(19) United States
(12) Patent Application Publication
(10) Pub. No.: US 2022/0105857 A1
(43) Pub. Date: Apr. 7, 2022

(54) CONVERTIBLE UTILITY TRAILER AND BOAT APPARATUS

(71) Applicant: Greg Roosenmaallen, Kingston (CA)

(72) Inventor: Greg Roosenmaallen, Kingston (CA)

(21) Appl. No.: 17/063,655

(22) Filed: Oct. 5, 2020

(51) Int. Cl. B60P 3/10

(52) U.S. Cl. CPC B60P 3/1066

(57) ABSTRACT

A utility trailer boat apparatus that is configurable between a first configuration as a boat and a second configuration as a utility trailer. The apparatus of the present invention includes a body having a first portion and a second portion. The first portion of the body is hingedly secured to the second portion of the body. Both the first portion and second portion of the body include a bottom and four walls wherein the first portion and second portion are similarly sized. In the first configuration the first portion and second portion are adjacent to each other in a linear arrangement. In the second configuration the first portion has been hinged over the second portion so as to be superposed thereto. A frame member is releasably secured to the bottom of the second portion and further includes a wheel assembly so as to provide movability of the apparatus.

### FIELD OF THE INVENTION

The present invention relates generally to outdoor equipment, more specifically but not by way of limitation, a convertible utility trailer that is configured to receive, store and transport items such as but not limited to camping gear and further be configured to transition between a trailer and a boat configuration.

### BACKGROUND

Many individuals routinely engage in recreational activities such as but not limited to outdoor recreation. There are numerous popular outdoor recreation activities that include but are not limited to hiking, camping and boating. For the latter two of the aforementioned it is often popular that individuals will explore remote areas wherein the individual will camp in areas that have small bodies of water. Many people that explore for remote camping and other general wilderness areas will do so utilizing a vehicles such as but not limited to all-terrain vehicles. These vehicles are utilized to assist in traversing the terrain and reaching a desired remote location. The all-terrain vehicles further are utilized to tow utility trailers that are configured to store and transport camping gear and the like.

One challenge for individuals traversing to remote areas is the ability to bring all of the desired gear for their trip. For extended camping trips often individuals must utilize a conventional small utility trailer to transport all of the required camping gear. When a small utility trailer is utilized, this eliminates the ability for an individual to additionally transport items such as but not limited to a boat. It is often desirable for an individual to be able to transport both camping gear and a small boat to explore bodies of water. Modifications to trailers and boats have been attempted but have fell short of achieving the desired objective. Additionally, for many individuals storage space in their garage or other similar area is very limited and as such many do not have storage room for both a utility trailer and a small boat.

Accordingly, there is a need for a convertible utility trailer and boat apparatus wherein the apparatus of the present invention is a towable trailer capable of storing items in a first configuration and in a second configuration be configured as a functional boat.

### SUMMARY OF THE INVENTION

It is the object of the present invention to provide a convertible utility trailer and boat apparatus that can be transitioned between a first configuration and a second configuration wherein the present invention includes a body having a first portion and a second portion.

Another object of the present invention is to provide an apparatus configurable as a boat and a utility trailer that is towable with an all-terrain vehicle wherein the first portion and second portion of the body are hingedly secured.

A further object of the present invention is to provide a convertible utility trailer and boat apparatus that can be transitioned between a first configuration and a second configuration wherein the second portion of the body is releasably superposed a frame.

Still another object of the present invention is to provide an apparatus configurable as a boat and a utility trailer that is towable with an all-terrain vehicle wherein the frame includes a wheel assembly.

An additional object of the present invention is to provide a convertible utility trailer and boat apparatus that can be transitioned between a first configuration and a second configuration wherein the frame further includes a vertical support member.

Yet a further object of the present invention is to provide an apparatus configurable as a boat and a utility trailer that is towable with an all-terrain vehicle wherein in the first configuration the first portion is superposed the second portion so as to form an interior volume.

Another object of the present invention is to provide a convertible utility trailer and boat apparatus that can be transitioned between a first configuration and a second configuration wherein the first portion and second portion of the body includes a bottom contiguously formed with a plurality of sidewalls forming an interior volume having an opening.

An alternate object of the present invention is to provide an apparatus configurable as a boat and a utility trailer that is towable with an all-terrain vehicle that further includes at least one over center latch locking member.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a top perspective view of the present invention in its first configuration; and

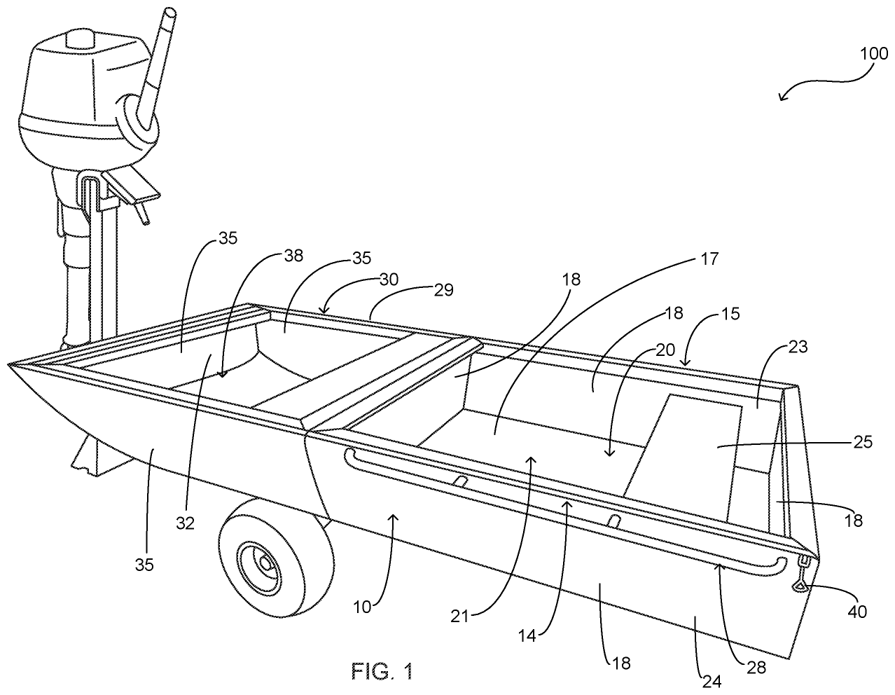

FIG. 2 is a perspective view of the frame of the present invention; and

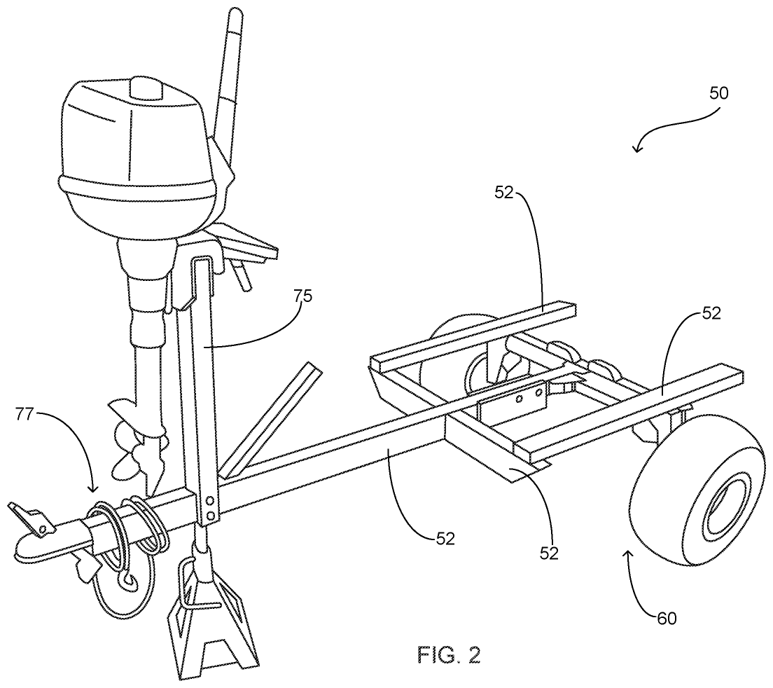

FIG. 3 is a detailed view of the body of the present invention being transitioned between its first and second configuration; and

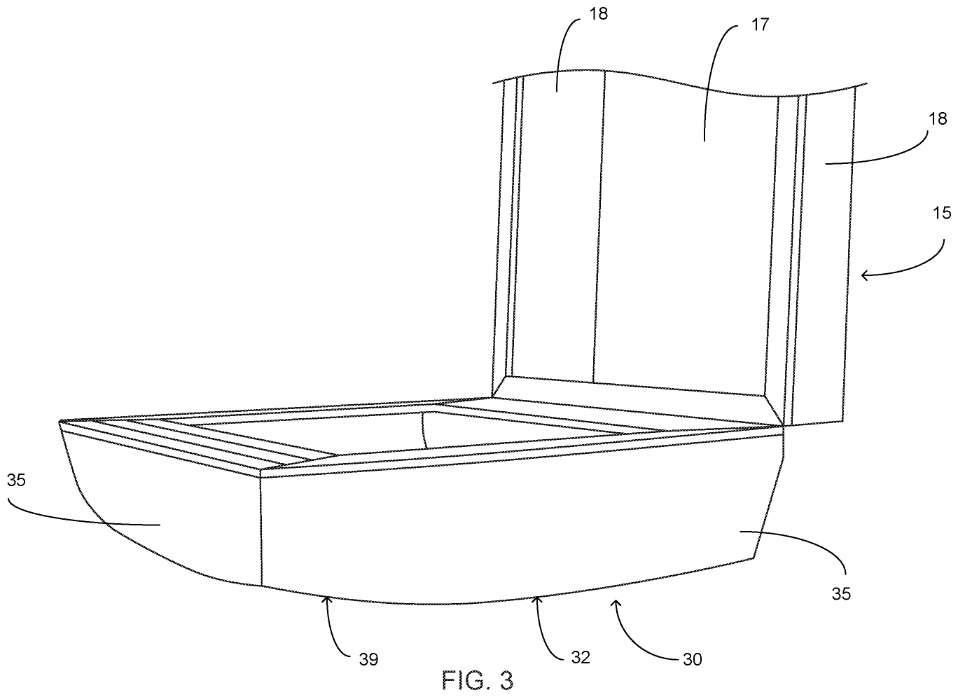

FIG. 4 is a view of the present invention in its second configuration.

### DETAILED DESCRIPTION

Referring now to the drawings submitted herewith, wherein various elements depicted therein are not necessarily drawn to scale and wherein through the views and figures like elements are referenced with identical reference numerals, there is illustrated a utility trailer boat apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted as a part hereof, the utility trailer boat apparatus 100 includes a body 10 wherein the body is comprised of a first portion 15 and a second portion 30. The body 10 is manufactured from a suitable durable material such as but not limited to aluminum. The first portion 15 includes a bottom 17 that is contiguously formed with walls 18 so as to define an interior volume 20 wherein the interior volume 20 is accessible via opening 21. In a preferred embodiment of the present invention the first portion 15 includes four walls 18 defining the shape thereof. The first portion 15 includes a seat member 25 that is operably disposed within the interior volume 20 and is intermediate opposing sidewalls 23,24. The seat member 25 is secured utilizing suitable techniques such as but not limited to welding. While one seat member 25 is illustrated in the embodiment herein, it is contemplated within the scope of the present invention that the first portion 15 could have more than one seat member 25. Secured to the exterior surface of the sidewall 24 is rail member 28. Rail member 28 is proximate the perimeter edge 14 of the first portion 15 and extends substantially the length of the sidewall 24. The rail member 28 is manufactured from durable material such as but not limited to aluminum tubing. It is contemplated within the scope of the present invention that the rail member 28 could be provided in alternate sizes and shapes and further be present on both sidewalls 23,24.

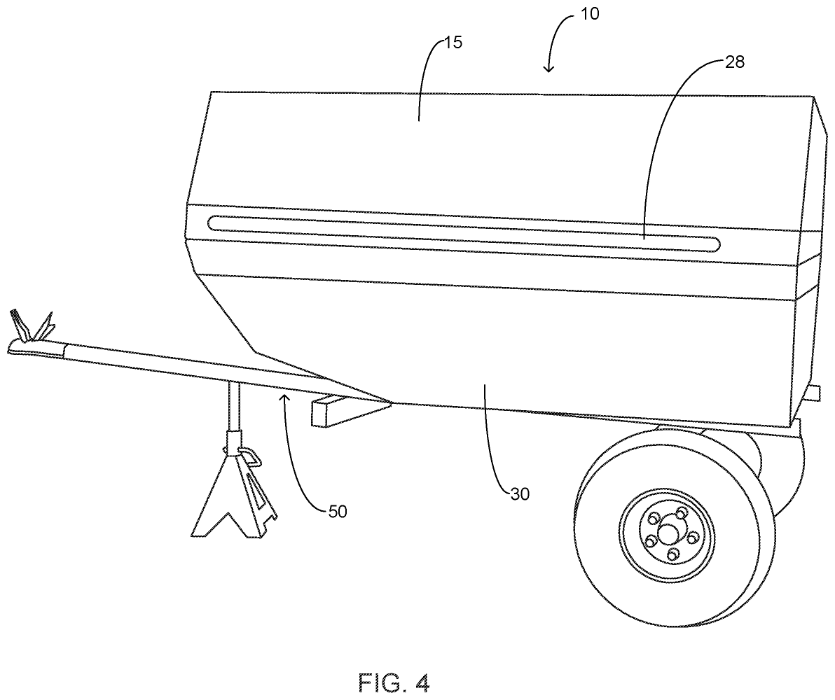

The second portion 30 of the body 10 is manufactured similarly to the first portion 15. The second portion 30 includes a bottom 32 and a plurality of walls 35 that are contiguously formed so as to create an interior volume 38. The bottom 32 includes a curved section 39 wherein the curved section 39 provides a desired performance when the utility trailer boat apparatus 100 is being utilized as a boat. The second portion 30 is sized so as to be equivalent in size to the first portion 15 in order to facilitate a mateable coupling when the utility trailer boat apparatus 100 is placed in its second configuration so as to function as a utility trailer. In the second configuration, the perimeter edges 14,29 are adjacent each other so as to form an enclosure as is illustrated herein in FIG. 4. In this configuration the body 10 is operable to receive, store and transport various items. The body 10 is releasably secured into its second configuration utilizing latch members 40.

The utility trailer boat apparatus 100 further includes a frame member 50. The frame member 50 is comprised of a plurality of support members 52 that are operably coupled utilizing suitable techniques such as but not limited to welding or mechanical fasteners. The support members 52 are manufactured from a suitable durable material such as but not limited to metal. It should be understood within the scope of the present invention that the support members 52 could be provided in alternate sizes and arranged in alternate arrangements and still achieve the desired objective of the present invention of receiving and transporting the body 10 in its second configuration. The frame member 50 includes a wheel assembly 60 wherein the wheel assembly 60 is a conventional wheel assembly having an axle and two wheels operable to rollably move the utility trailer boat apparatus 100.

The frame member 50 further includes a vertical support member 75 that is positioned near the tongue member 77. The vertical support member 75 is secured utilizing suitable techniques and is operable to provide an element to secure and transport items such as but not limited to small outboard motors. It is contemplated within the scope of the present invention that the vertical support member 75 could be provided in alternate sizes, locations and quantities.

It should be understood within the scope of the present invention that the body 10 is secured in its first configuration wherein the body 10 functions as a small boat. The securing of the body 10 in its first configuration can be accomplished with fasteners such as but not limited to an over center latch. Furthermore, it should be understood within the scope of the present invention that the first portion 15 and second portion 30 can be hingedly secured utilizing various types of hinge mechanisms. Additionally, the body 10 can be secured to the frame member 50 utilizing various techniques.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A utility trailer boat apparatus operable to be utilized in a first configuration and a second configuration comprising:
a body, said body having a first portion and a second portion, said first portion of said body having a bottom and at least one wall configured to form an interior volume, said second portion of said body having a bottom and at least one wall configured to form an interior volume, said first portion having an opening providing access to said interior volume of said first portion, said second portion having an opening providing access to said interior volume of said second portion, said first portion and said second portion being hingedly secured;
a frame member, said first portion configured to be releasably secured to said frame member, said frame member having a wheel assembly; and
wherein in said first configuration said first portion and said second portion of said body are adjacent to each other in a linear manner so as to provide utilization as a boat.

2. The utility trailer boat apparatus as recited in claim 1, wherein in said second configuration said first portion is superposed said second portion so as to form an enclosure.

3. The utility trailer boat apparatus as recited in claim 2, wherein the frame member further includes a vertical support member, said vertical support member configured to extend upward from a portion of said frame member.

4. The utility trailer boat apparatus as recited in claim 3, and further including a rail member, said rail member being secured to an outside surface of the at least one wall of said first portion, said rail member extending substantially along said first portion proximate a perimeter edge thereof.

5. The utility trailer boat apparatus as recited in claim 4, and further including a seat member, said seat member being disposed within the interior volume of said first portion.

6. The utility trailer boat apparatus as recited in claim 5, and further including at least one fastener, said at least one fastener configured to releasably secured said first portion to said second portion when said body is placed in said first configuration.

7. A utility trailer boat apparatus configured to be utilized as a boat and a trailer wherein the utility trailer boat apparatus comprises:
a body, said body having a first portion and a second portion, said first portion of said body having a bottom and four walls configured to create an interior volume, said second portion of said body having a bottom and four walls forming an interior volume, said four walls of said first portion being comprised of a front wall, a rear wall and two opposing side walls, said four walls of said second portion including a rear wall, said front wall of said first portion being hingedly coupled to said rear wall of said second portion;
a frame member, said frame member further including a plurality of support members, said plurality of support members configured to provide support for said second portion, said second portion being configured to be releasably secured to said frame member; and
wherein in said second configuration said first portion is hingedly moved so as to be superposed said second portion so as to create an enclosure wherein the interior volume of said first portion and the interior volume of said second portion are adjacent so as to store objects therein.

8. The utility trailer boat apparatus as recited in claim 7, wherein in said first configuration said first portion and said second portion are adjacent each other in a linear arrangement so as to provide utilization as a boat.

9. The utility trailer boat apparatus as recited in claim 8, wherein in said first configuration said front wall of said first portion and said rear wall of said second portion are releasably secured so as to maintain said body in said first configuration.

10. The utility trailer boat apparatus as recited in claim 9, and further including a rail member, said rail member being secured to an external surface of one of said opposing side walls of said first portion, said rail member configured to extend along said one of said opposing walls proximate an upper perimeter edge.

11. The utility trailer boat apparatus as recited in claim 10, wherein said bottom of said second portion includes a curved section wherein the curved section is distal to said first portion.

12. The utility trailer boat apparatus as recited in claim 7, and further including at least two fasteners, said at least two fasteners configured to releasably secured said first portion to said second portion when said body is placed in said first configuration, said at least two fasteners being proximate said rear wall of said first portion.

13. The utility trailer boat apparatus as recited in claim 12, and further including a seat member, said seat member being disposed within the interior volume of said first portion, said seat member extending between said opposing sidewalls of said first portion.

14. The utility trailer boat apparatus as recited in claim 13, wherein the frame member further includes a vertical support member, said vertical support member configured to extend upward from a portion of said frame member.

15. A utility trailer boat apparatus having a first configuration to be utilized as a boat and a second configuration to be utilized as a trailer wherein the utility trailer boat apparatus comprises:
a body, said body having a first portion and a second portion, said first portion of said body having a bottom and four walls configured to create an interior volume, said second portion of said body having a bottom and four walls forming an interior volume, said four walls of said first portion being comprised of a front wall, a rear wall and two opposing side walls, said four walls of said second portion including a rear wall, said front wall of said first portion being hingedly coupled to said rear wall of said second portion;
a frame member, said frame member further including a plurality of support members, said plurality of support members configured to provide support for said second portion, said second portion being configured to be releasably secured to said frame member; and
wherein in said second configuration said first portion is hingedly moved so as to be superposed said second portion so as to create an enclosure wherein the interior volume of said first portion and the interior volume of said second portion are adjacent so as to store objects therein and wherein in said first configuration said first portion and said second portion are adjacent each other in a linear arrangement so as to provide utilization as a boat and wherein in said first configuration said body is removed from said frame member.

16. The utility trailer boat apparatus as recited in claim 15, wherein the frame member further includes a vertical support member, said vertical support member configured to extend upward from a portion of said frame member.

17. The utility trailer boat apparatus as recited in claim 16, and further including a seat member, said seat member being disposed within the interior volume of said first portion, said seat member extending between said opposing sidewalls of said first portion.

18. The utility trailer boat apparatus as recited in claim 17, and further including at least two fasteners, said at least two fasteners configured to releasably secured said first portion to said second portion when said body is placed in said first configuration, said at least two fasteners being proximate said rear wall of said first portion.
